(19) United States
(12) Patent Application Publication
(10) Pub. No.: US 2002/0139622 A1
(43) Pub. Date: Oct. 3, 2002

(54) Rotor disk for car disc brake

(76) Inventor: Lai-Lin Chen, Yung-Kang City (TW)

Correspondence Address: DAVID E. DOUGHERTY, DENNISON, SCHULTZ & DOUGHERTY, 612 CRYSTAL SQUARE 4, 1745 JEFFERSON DAVIS HIGHWAY, ARLINGTON, VA, 22202, US

(21) Appl. No.: 09/818,755

(22) Filed: Mar. 28, 2001

(51) Int. Cl. B60T 1/06

(52) U.S. Cl. 188/218 XL; 188/17

(57) ABSTRACT

An improvement of rotor disk for car disc brake includes a rotor disk and a fastening hub. The rotor disk has an opening in the center, a reinforced ring surrounding the opening and a plurality of screw bores formed in the reinforced ring. The fastening hub has a flange which has a plurality of screw bores engageable with the screw bores of the rotor disk. The flange may engage closely with the reinforced ring to increase the strength of total structure for withstanding greater stress thereby to increase stability and safety. It also may be adapted to different car modals to increase its compatibility.

### BACKGROUND OF THE INVENTION

This invention relates to an improvement of rotor disk for car disc brake and particularly a rotor disk that has a reinforced ring surrounding the rotor disk opening for fastening to the screw bores of a fastening hub thereby to increase the strength of total structure to withstand greater stress and is capable of adapting to different car modals to enhance its compatibility.

The disc brakes now being commonly used in the cars generally have the following two types:

1. An one piece disc brake as shown in FIG. 1 which mainly includes a rotor disk 1 with a protrusive and integrally formed fastening hub 10. The hub 10 has an axle bore 11 formed in the center. Around the axle bore 11, there are a plurality of fastening apertures 12. The hub 10 and fastening apertures 12 are fixedly formed, thus cannot be adapted to different car models and has a severe part compatibility problem. Different types of molds have to be made for producing different types of disc brakes to suit different car modals. It creates a lot of utilization problems and also significantly increases the costs.

2. In order to make the disc brake adaptable to various car models, there is a two-piece type disc brake being introduced as shown in FIG. 2. It constitutes a rotor disk 2 and a fastening hub 20. The rotor disk 2 has screw bores 21. The fastening hub 20 has an axle bore 200 and screw bores 201. To match different car models, only the fastening hub 20 of a different size needs to be changed. The selected fastening hub 20 then may be fastened to the rotor disk 2 through the screw bore 21. Such a design and construction makes assembly easier and may save cost.

However the two-piece type disc brake has relatively weak structural strength and cannot withstand great stress. The screwing spots are prone to break down and damage. There are still rooms for improvement.

### SUMMARY OF THE INVENTION

In view of aforesaid disadvantages, it is therefore an object of this invention to provide an improved disc brake that has a two-piece structure but with a reinforced ring formed on the rotor disk so that it has an increased structural strength to withstand greater stress and an enhanced compatibility to suit different car modals easily.

### BRIEF DESCRIPTION OF THE DRAWINGS

The invention, as well as its many advantages, may be further understood by the following detailed description and drawings, in which:

FIG. 1 is a perspective view of a conventional one piece type disc brake.

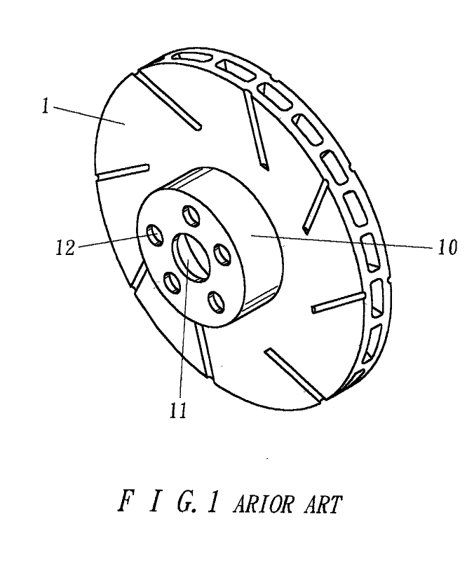

FIG. 2 is an exploded view of a conventional two-piece type disc brake.

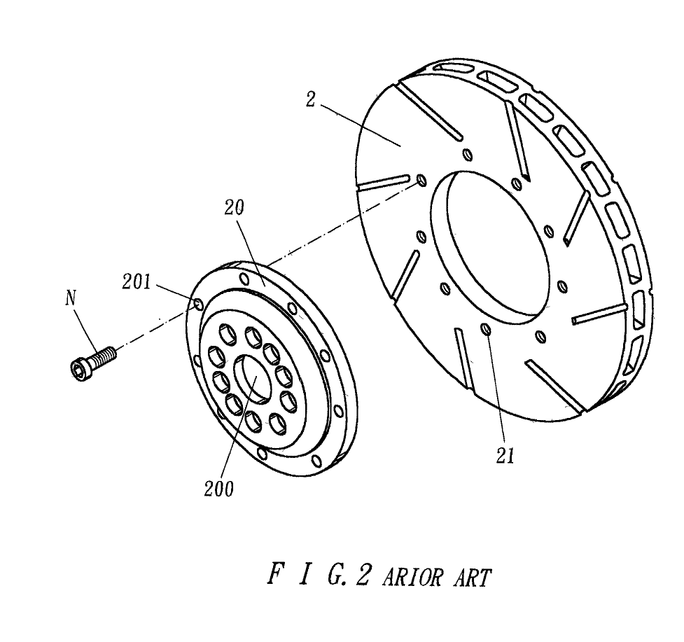

FIG. 3 is an exploded view of an embodiment of this invention.

FIG. 4 is a perspective view of an embodiment of this invention.

FIG. 5 is a sectional view of an embodiment of this invention.

FIG. 6 is an exploded view of another embodiment of this invention.

FIG. 7 is a perspective view of another embodiment of this invention.

FIG. 8 is a sectional view of another embodiment of this invention.

FIG. 9 is an exploded view of yet another embodiment of this invention.

FIG. 10 is a perspective view of yet another embodiment of this invention.

FIG. 11 is a sectional view of yet another embodiment of this invention.

### DETAILED DESCRIPTION OF THE PREFERRED EMBODIMENTS

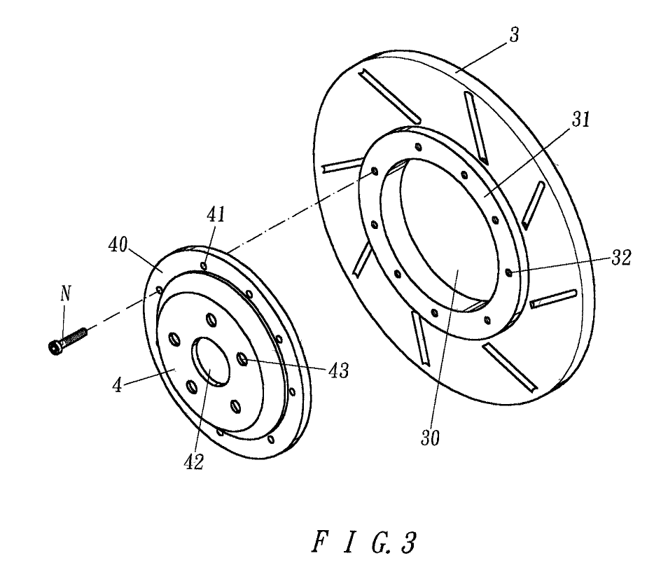

Referring to FIG. 3, the disc brake according to this invention mainly includes a rotor disk 3 which has an opening 30 formed in the center surrounded by a reinforced ring 31. On the reinforced ring, there are a plurality of screw bores 32. There is a fastening hub 4 for screwing to the rotor disk 3. The fastening hub 4 has a circular flange 40 which has a plurality of screw bores 41 mating against the screw bores 32, an axle bore 42 formed in the center and surrounded by a plurality of fastening apertures 43 and a protrusive ring 40′.

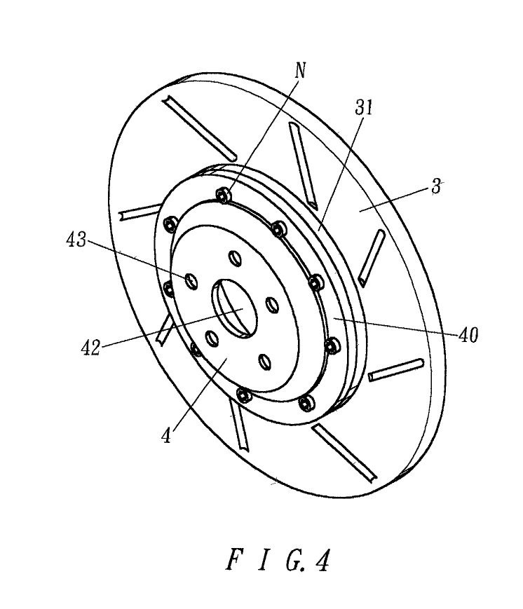

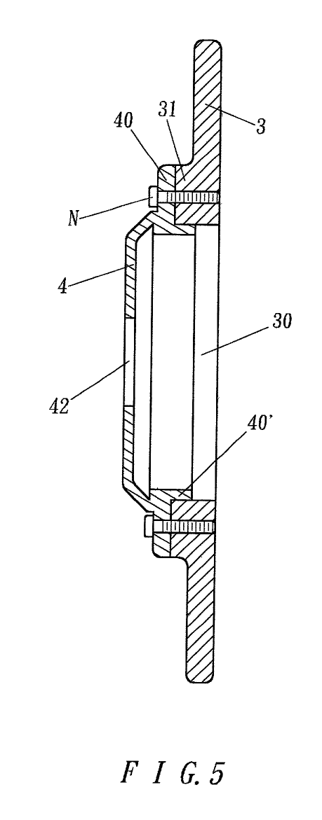

Referring to FIGS. 4 and 5, the flange 40 and ring 40′ of the fastening hub 4 may match against the reinforced ring 31 of the rotor disk 3 with the screw bores 32 aligned with the screw bores 41, then bolts N may be screwed into the screw bores 32 and 41 to fasten the rotor disk 3 and fastening hub 4 together to become a firm assembly. The assembly then may be disposed on the car chassis with the axle bore 42 mounting on the car axle, and fastened to the car chassis through the fastening apertures 43. The fastening hub 4 is fastened to the rotor disk 3 through the reinforced ring 31, thus greatly increases the mechanical strength and will withstand greater stress. Thus whole structure has more steadiness and integrity, and will greatly enhance driving safety.

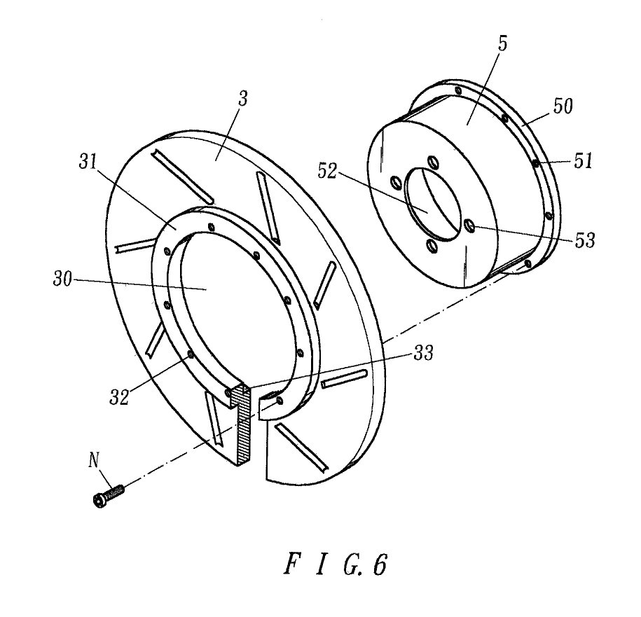

FIG. 6 shows another embodiment of this invention. It mainly includes a rotor disk 3 which has an opening 30 formed in the center surrounded by a reinforced ring 31. On the reinforced ring 31, there are a plurality of screw bores 32. At the bottom side of the reinforced ring 31, there is a fastening rim 33. There is a fastening hub 5 for screwing to the rotor disk 3 at the fastening rim 33. The fastening hub 5 has a circular flange 50 which has a plurality of screw bores 51 mating against the screw bores 32, an axle bore 52 formed in the center and surrounded by a plurality of fastening apertures 53.

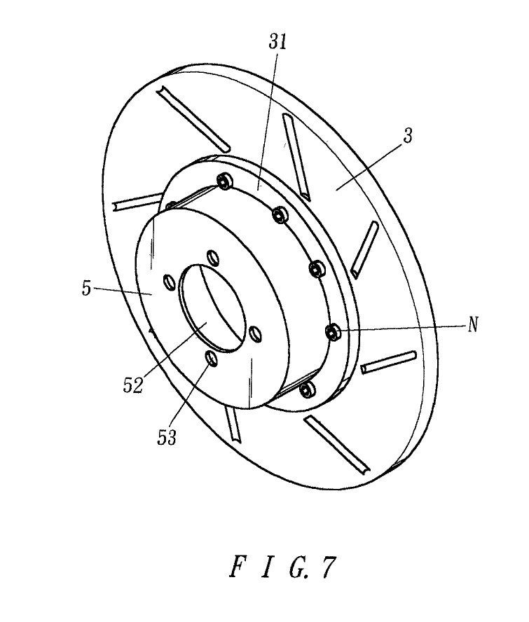

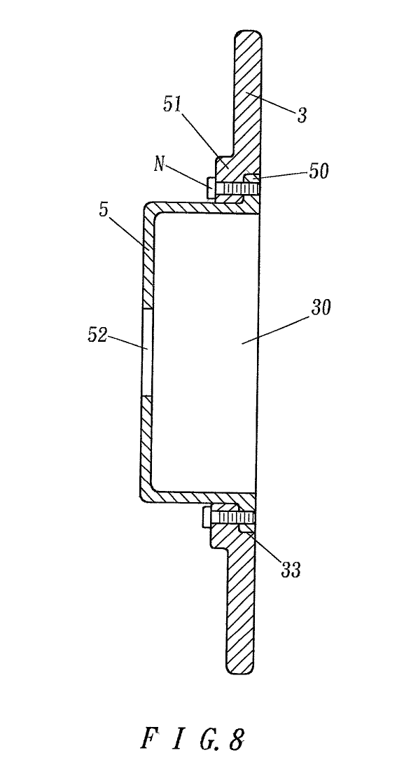

Referring to FIGS. 7 and 8, the flange 50 of the fastening hub 5 may be disposed in the fastening rim 33 of the rotor disk 3 with the screw bores 32 aligned with the screw bores 51, then bolts N may be screwed into the screw bores 32 and 51 to fasten the rotor disk 3 and fastening hub 5 together to become a firm assembly. The flange 50 may engage closely with the fastening rim 33 of the reinforced ring 31 to increase strength and may be adapted to different car modals.

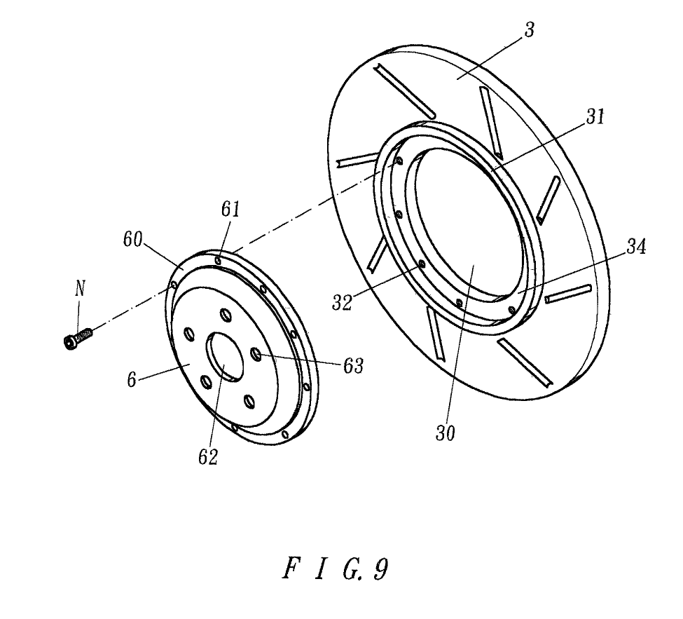

FIG. 9 shows yet another embodiment of this invention. It mainly includes a rotor disk 3 which has an opening 30 formed in the center surrounded by a reinforced ring 31. On the reinforced ring 31, there are a plurality of screw bores 32. At the top side of the reinforced ring 31, there is a fastening rim 34. There is a fastening hub 6 which has a circular flange 60 and a protrusive ring 60′, an axle bore 62 formed in the center and surrounded by a plurality of fastening apertures 63. The flange 60 has a plurality of screw bores 61 mating against the screw bores 32,

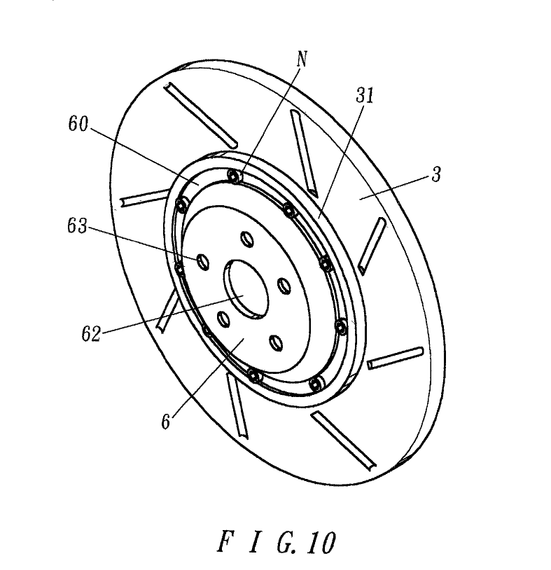

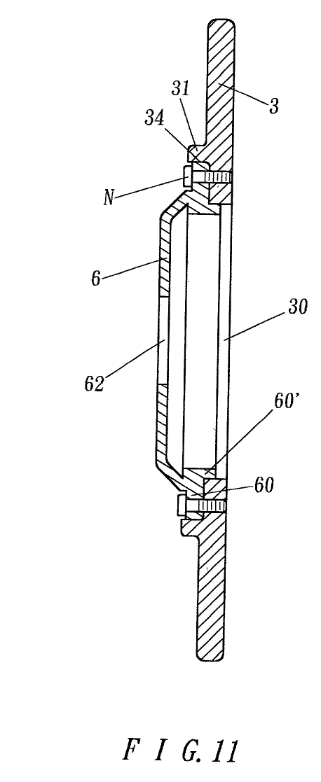

Referring to FIGS. 10 and 11, the flange 60 and ring 60′ of the fastening hub 6 may be disposed in the fastening rim 34 of the rotor disk 3 with the screw bores 32 aligned with the screw bores 61, then bolts N may be screwed into the screw bores 32 and 61 to fasten the rotor disk 3 and fastening hub 6 together to become a firm assembly. The flange 60 and ring 60′ may engage closely with the fastening rim 34 of the reinforced ring 31 to increase strength and may be adapted to different car modals.

By means of the foregoing construction, this invention offers the following advantages:

1. The rotor disk has a reinforced ring to engage with the fastening hub thereby to increase the structural strength of the whole body and may withstand greater destructive stress and enhance safety.

2. This invention may be adapted to different car modals easily with different fastening hubs, thus may increase the components compatibility and save production cost and time.

While the preferred embodiments of the invention have been set forth for purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An improvement of rotor disk for car disc brake, comprising:
a rotor disk having an opening in the center thereof, and a reinforced ring surrounding the opening, the reinforced ring having a plurality of screw bores formed therein; and
a fastening hub for screwing to the rotor disk having a circular flange which has a plurality of screw bores formed therein, an axle bore formed in the center thereof and a plurality of fastening apertures formed around the axle bore.

2. The improvement of rotor disk of claim 1, wherein the reinforced ring has a fastening rim formed at the bottom side thereof.

3. The improvement of rotor disk of claim 1, wherein the reinforced ring has a fastening rim formed at the top side thereof.
